(19) United States
(12) Patent Application Publication
(10) Pub. No.: US 2009/0130266 A1
(43) Pub. Date: May 21, 2009

(54) METHOD FOR PRESERVING FLAVOR COMPONENT

(76) Inventors: Tetsuya Arita, Shiga (JP); Yoshiaki Yokoo, Tokyo (JP)

Correspondence Address: DRINKER BIDDLE & REATH (DC), 1500 K STREET, N.W., SUITE 1100, WASHINGTON, DC, 20005-1209, US

(21) Appl. No.: 11/792,825

(22) PCT Filed: Dec. 12, 2005
(86) PCT No.: PCT/JP2005/022757

§ 371 Date: Dec. 16, 2008

(30) Foreign Application Priority Data
Dec. 13, 2004 (JP) 2004-360594

(51) Int. Cl. A23L 3/34; A23L 1/22; A23L 2/00; A23L 2/38; A23B 9/16; A23L 3/36

(52) U.S. Cl. 426/106; 426/330; 426/327; 426/321; 426/324

(57) ABSTRACT

A method for preserving a liquid that contains a flavor component derived from a food material, comprising adding a pH-adjuster to the liquid.

### TECHNICAL FIELD

The present invention relates to a method for preserving a liquid that contains a flavor component derived from food materials.

### BACKGROUND ART

Food flavorings are used in food, beverages, and the like; and accentuate the flavors of these items. Alternatively, food flavorings provide variations in flavor and are used primarily in order to increase the palatability of the food or beverage to which the flavoring is provided. Food flavorings include natural flavors, artificial flavors, and mixed flavors resulting from combining natural and artificial flavors. Accompanying the predilection of consumers for authentic-tasting foods and beverages in recent years, the tendency has been for natural flavorings or compounds similar to natural flavorings to be desired as the food flavorings employed.

However, natural flavorings are generally a mixture of a variety of natural flavor components (referred to below as “flavor components”), and some of these flavor components have extremely low preservation stability in aqueous solution. For example, natural flavorings obtained from roasted food items (roasted coffee beans, oats, barley, brown rice, sesame seeds, and the like) contain large amounts of flavor components composed of nitrogen-containing compounds, sulfur-containing compounds, and other chemically unstable species, and the preservation stability of these materials in aqueous solution is low.

A variety of stabilizing agents (additives) are conventionally used in order to increase the preservation stability of flavor components in aqueous solution. Propylene glycol, ethanol, other organic solvents, trehalose and vitamin C (see Patent Document 1), or coumarin derivatives (see Patent Document 2) and are examples of stabilizing agents (additives) in general use.

Other methods for increasing the preservation stability of flavor components include preservation by refrigeration or freezing of solutions containing the flavor components.

[Patent Document 1] Japanese Laid-Open Patent Application 2001-292721

[Patent Document 2] Japanese Laid-Open Patent Application 2001-136931

### DISCLOSURE OF THE INVENTION

### Problems that the Invention is Intended to Solve

The aforedescribed stabilizing agents are added to solutions containing flavor components, which may have a negative effect on the unique flavor of the flavor components. These effects have tended to be disliked by modern consumers, who have a strong predilection for authentic tastes.

Methods for preserving solutions containing flavor components by refrigeration or freezing without the addition of stabilizing agents have accordingly been considered.

Methods of preservation by refrigeration more or less improve preservation stability relative to preservation at room temperature but may not result in adequate preservation stability for unstable flavor components.

Meanwhile, in the case of methods of preservation by freezing, which have a lower preservation temperature than preservation by refrigeration, the flavor components are recovered as a liquid. The recovered liquid is stored in a bag or other container, after which the container (referred to below as a “sealed article”) is sealed and frozen. Preservation is thereby possible at a fairly low temperature, and adequate preservation stability is obtained.

However, the carbon dioxide that adheres to the surface of roasted food material during roasting may be recovered together with the flavor components during recovery from the roasted food material. When a liquid containing carbon dioxide and flavor components is frozen, the carbon dioxide contained in the liquid is separated as the liquid solidifies, and the volume of the sealed article swells. Storage space must be ensured for the extent of the swelling of the volume of sealed article. The number of sealed articles that can be loaded on a transport truck or the like is limited, and shipping efficiency deteriorates. Costs therefore increase at storage locations and during shipping.

The present invention was devised in light of the aforementioned problems. The present invention provides a method for preserving a flavor component in which the preservation stability of a chemically unstable flavor component is improved without adding special stabilizing agents, and in which reductions are achieved in the costs of storing and shipping sealed articles containing flavor components recovered from roasted food material.

### Means for Solving the Problems

The invention according to a first aspect provides a method for preserving a liquid that contains a flavor component derived from a food material, comprising adding a pH-adjuster to the liquid.

According to this aspect, the preservation stability of the flavor components can be improved without using special stabilizing agents.

Natural flavor components derived from food materials are numerous and varied, and the stabilities of these components in aqueous solution are all different. For example, basic compounds are stable in aqueous solutions having a relatively low pH value, but acidic compounds are stable in aqueous solutions having a relatively high pH value. The stability of natural flavor components therefore depends to a certain extent on the pH value of the aqueous solution containing the flavor components. The preservation stability of the flavor components can therefore be improved without adding special stabilizing agents if the pH value of the aqueous solution that contains the natural flavor components is adjusted.

Changing the pH value may affect the flavor or the strength of the flavor components, but the pH value must be adjusted for container-packed beverages, and few drawbacks are presented.

The invention according to a second aspect comprises preserving without heating the liquid to which the pH-adjuster has been added.

According to this aspect, preservation is possible without the dispersal of the flavor components.

In a third aspect of the present invention, the pH of the liquid to which the pH-adjuster is added is 6 to 10.

According to this aspect, the pH of the liquid can be adjusted to, e.g., near a moderate (pH7) level, and therefore flavor components that are unstable in acidic or alkaline conditions can be chemically stabilized. Ionization of carbon dioxide in the liquid is promoted in liquids having a pH value in the vicinity of approximately 6 to 10, and therefore swelling of the volume of the sealed articles during preservation by freezing can be prevented.

The invention according to a fourth aspect comprises subjecting the liquid to which the pH-adjuster has been added to preservation by freezing.

According to this aspect, deterioration of the flavor components over time can be delayed, and preservation stability can be further improved. An effect in which the deposition of flavor components during freezing is minimized can also be expected depending on the flavor components contained in the liquid.

Changing the pH value may affect the flavor or the strength of the flavor components, but appropriate acids or bases can be added or other actions can be performed as necessary to restore the original pH value at the time of thawing and usage. The flavor and strength of the flavor components are therefore not particularly adversely affected.

In a fifth aspect of the present invention, the pH-adjuster is an alkaline substance.

According to this aspect, an alkaline pH-adjuster is added when, e.g., the liquid containing the flavor component is acidic, whereby the pH value of the liquid can be adjusted to a moderate range. Flavor components that are unstable in acidic conditions can therefore be chemically stabilized.

In a sixth aspect of the present invention, the alkaline substance is at least one substance selected from the group consisting of sodium hydroxide, sodium bicarbonate, potassium hydroxide, and trisodium phosphate.

According to this aspect, these reagents are commonly sold and easy to procure.

In a seventh aspect of the present invention, the food material is a roasted food material.

According to this aspect, flavor components recovered from a roasted food material can be chemically stabilized and volumetric swelling of sealed articles can be limited when freezing sealed articles in which a liquid containing carbon dioxide and the flavor components is sealed.

In other words, carbon dioxide, which adheres to the surface of roasted food articles during roasting, may be recovered along with the flavor components during recovery from the roasted food material. The carbon dioxide is dissolved into the liquid (recovered liquid) that contains the flavor components, and the recovered liquid is acidic due to the action of carbonic acid. Therefore, if the pH of the recovered liquid is adjusted using the pH-adjuster (the alkaline substance), the pH value can be adjusted to a moderate range, and the flavor components that are unstable in acidic conditions in particular can be chemically stabilized.

When the liquid containing the flavor components and carbon dioxide is, e.g., frozen, the carbon dioxide contained in the liquid will be separated as the liquid solidifies, and volumetric swelling of the bag or other sealed article into which such a liquid is filled and sealed may occur. However, the ionization (to HCO₃— or CO₃²⁻) of carbon dioxide gas (CO₂) is incited when an alkaline substance is added to the liquid and the pH value of the liquid is adjusted (raised), and the separation of carbon dioxide gas can be prevented during freezing. As a result, volumetric swelling of the sealed articles is limited, and the cost of storing and shipping sealed articles can be reduced.

In an eighth aspect of the present invention, the roasted food material is selected from the group consisting of coffee beans, tea, oats, barley, brown rice, and sesame seeds.

According to this aspect, these food materials are widely used in human diets, are able to be easily (inexpensively) procured, and are also appropriate as industrial raw materials.

In a ninth aspect of the present invention, the temperature of the preservation by freezing is −50° C. to −10° C.

According to this aspect, preservation in an extremely low-temperature environment is not necessary, and supplying, removing, and storing the sealed articles can be performed as manual tasks. As long as the temperature is in this range, the stability of the raw materials can be ensured for approximately 1.5 months or half a year, which is an adequate storage period for raw materials during which beverage production will not be compromised.

In a tenth aspect of the present invention, the liquid to which the pH-adjuster has been added may be added to a container-packed beverage.

According to this aspect, container-packed beverages (e.g., canned coffee) that contain flavor components derived from food materials (roasted food materials) can be manufactured to suit consumer preferences.

The invention according to an eleventh aspect provides a method for manufacturing a container-packed beverage, comprising adding a flavor component preserved by the method for preservation by freezing of a flavor component according to any of the first through tenth aspects.

According to this aspect, container-packed beverages (e.g., canned coffee) that contain flavor components derived from food materials (roasted food materials) can be industrially produced to suit consumer preferences.

The invention according to a twelfth aspect provides a container-packed beverage that is manufactured using the manufacturing method according to the eleventh aspect.

According to this aspect, the container-packed beverage has a high palatability and reproduces natural flavors (aromas), which have been difficult to reproduce in conventional container-packed beverages.

In a thirteenth aspect of the present invention, the container-packed beverage is a coffee beverage.

According to this aspect, the coffee beverage has a high palatability due to reproducing flavors derived from roasted coffee beans. These flavors have been difficult to reproduce in conventional canned coffees and the like.

### BEST MODE FOR CARRYING OUT THE INVENTION

A method for acquiring natural flavor components from natural food materials will be described.

Ideal examples of natural food materials in the present invention include coffee, tea, oats, brown rice, sesame seeds, and other roasted food materials.

The aforementioned natural food materials can be used directly without modification, but apparatuses used in food manufacture and the like are typically used to cut, grind, pulverize or otherwise pretreat the food materials, which are then provided to means for recovering flavor, whereby the distillation of flavor components is more effectively facilitated. The means for recovering flavor is not particularly limited and may be, e.g. the means employed in well-known methods such as steam distillation methods and gas-liquid counter-flow contact extraction methods.

Steam distillation methods involve venting water vapor through the raw materials and condensing flavor components distilled along with the water vapor. Pressurized steam distillation, normal-pressure steam distillation, or vacuum steam distillation can be employed according to the type or other property of the raw food material.

As a specific example, water vapor is blown from the bottom of a steam distillation still which has been prepared with the aforedescribed roasted food material. The distillate vapor is cooled in a condenser connected to the distillation area on the upper part. A distilled liquid containing volatile flavor components is thereby collected as the condensate. When necessary, volatile flavor components having lower boiling points can be reliably collected when a cold trap employing a refrigerant is connected upstream of the apparatus for collecting flavor components.

Gas-liquid counter-flow contact extraction methods can be implemented using various well-known methods. A method may employed in which extraction is performed using, e.g., the apparatus described in Japanese Examined Patent Application No. 61-274705. Specific means for recovering flavor components using this apparatus will be described.

First, a liquid or paste-form natural food material is caused to flow down from the top of a spinning cone of a gas-liquid counter-flow contact extraction apparatus having a structure in which spinning cones and stationary cones are combined in alternation. Vapor is made to rise from the bottom, whereupon the flavor components that are naturally present in the natural food material can then be recovered. The operational conditions of the gas-liquid counter-flow contact extraction apparatus can be freely selected according to the processing power of the apparatus, the type and concentration of the natural food material, the strength of the flavors, and other factors. A specific example is given below.

Raw-material supply rate: 300 to 700 L/hr

Vapor flow volume: 5 to 50 kg/hr

Amount of vaporization: 3 to 35 kg/hr

Temperature at bottom of column: 40° C. to 100° C.

Temperature at top of column: 40° C. to 100° C.

Extent of vacuum: Atmospheric pressure to −100 KPa

When necessary, volatile flavor components having lower boiling points can be reliably collected when a cold trap employing a refrigerant is connected upstream of the apparatus.

The present invention relates to a method for preserving natural flavor components contained in an aqueous solution (that may contain carbon dioxide) and obtained from a natural food material by the means for recovering flavor.

The type of pH-adjuster mixed into the aqueous solution containing the flavor components is not particularly limited and may be changed according to the type or other property of the natural food material that is used as the raw material. Aqueous solutions containing flavor components are frequently acidic, and therefore the pH-adjuster is preferably an alkaline substance, e.g., sodium hydroxide, sodium bicarbonate, potassium hydroxide, or trisodium phosphate.

The pH value dictates the amount of pH-adjuster added. The pH value should be 6 to 10, and preferably 7 to 9.

The pH-adjusted aqueous solution containing the flavor components is stored in a bag-in-box, aluminum bag, or other sealed container.

Heat sterilization before filling is preferable for minimizing the growth of microorganisms, but heat sterilization also affects the dispersal of flavor components and carbon dioxide. An appropriate decision should therefore be made as to the necessity of performing heat sterilization and other heating operations on aqueous solutions containing flavor components.

Since the extent of volumetric swelling during freezing is reduced in aqueous solutions that contain flavor components and amounts of carbon dioxide that are reduced due to heating operations, the present invention can be more suitably supplied in cases of no heating.

The preservation temperature may be set appropriately depending on the length of storage and other factors, but approximately −50° C. to −10° C. is preferable. By using the techniques of the present invention at these temperatures, the stability of the raw materials can be ensured for approximately 1.5 months or half a year, which is an adequate storage period for raw materials during which beverage production will not be compromised.

A large amount of carbon dioxide is included in the aqueous solution containing flavor components when coffee or another roasted food material is used as the raw material. Since the solubility of carbon dioxide is different in water than in ice, when this aqueous solution is frozen in a sealed container, the saturated carbon dioxide will be separated, and the volume of the sealed container will increase. According to the present invention, the pH is adjusted to 6 to 10, preferably 7 to 9, before freezing, whereby the amount of carbon dioxide that is separated is reduced, and volumetric swelling of the sealed container can be restrained.

Flavor components preserved by freezing as described above are thawed before being used as beverage raw materials and can be added to normal container-packed beverages. Beverages having a rich and natural flavor can thereby be provided.

### OTHER EMBODIMENTS

The method for preserving a flavor component of the present invention can be implemented in combination with a conventional method for improving the stability of flavor components by adding a stabilizing agent such as ethanol, propylene glycol, trehalose, vitamin C, or a coumarin derivative.

### EXAMPLES

### Examples will be given below, and the specifics of the present invention will be described, but the present invention is not limited to these examples.

### Example 1

10 kg of roasted coffee beans was mixed with pure water in a 1:9 ratio and ground to a particle diameter of approximately 1 mm. Volatile components were recovered from this liquid together with water vapor using a Flavourtech SCC (Spinning Cone Column), which is a type of gas-liquid counter-flow contact extraction apparatus, operating under the conditions below. The resulting volatile components were immediately cooled to 20° C. or less, and 5 liters of an aqueous solution containing flavor components was obtained.

Raw-material supply rate: 350 L/hr

Vapor flow volume: 17.5 kg/hr

Amount of vaporization: 17.5 kg/hr

Temperature at bottom of column: 98° C.

Temperature at top of column: 98° C.

Extent of vacuum: Atmospheric pressure

Invention Product (1): The pH value of the resulting aqueous solution containing flavor components was brought to 7.2 using sodium hydroxide (made by Kanto Chemical Co., Inc.) as a pH-adjuster, and the solution was preserved by freezing at −80° C. and −20° C. for 1.5 months.

Invention Product (2): The pH value of the resulting aqueous solution containing flavor components was brought to 7.2 using sodium bicarbonate (made by Kanto Chemical Co., Inc.) as a pH-adjuster, and the solution was preserved by freezing at −80° C. and −20° C. for 1.5 months.

Comparative product (1): The resulting aqueous solution containing flavor components was frozen and preserved at −80° C. and −20° C. for 1.5 months.

(Evaluation 1: Sensory Evaluation)

In the sensory evaluation, the strength of the flavor components was judged by five trained panelists according to the following five-tiered scale. 5: Conspicuous; 4: conspicuous in the main; 3: moderately conspicuous; 2: poor; 1: non-existent. The average values were calculated. The temperature of the samples during sensory testing was 20° C.

Sensory evaluations were performed on samples thawed to normal temperature at the start of preservation and after preservation. The results are shown in Table 1.

TABLE 1
Results of Sensory Evaluation

| | | pH (before | Start of | −80° C., | −20° C., |
|---|---|---|---|---|---|
| | pH- | preser- | preser- | 1.5 | 1.5 |
| | adjuster | vation) | vation | months | months |
| Invention | Sodium | 7.2 | 5 | 5 | 4.4 |
| Product 1 | hy- | | | | |
| | droxide | | | | |
| Invention | Sodium | 7.2 | 5 | 5 | 4.2 |
| Product 2 | bicar- | | | | |
| | bonate | | | | |
| Comparison | None | 4.5 | 5 | 5 | 3.9 |
| Product 1 | | | | | |

An effect of improved stability during long-term freezing storage at −20° C. due to pH adjustment is seen from the results of Table 1.

(Evaluation 2: Chemical Component Analysis)

Chemical component analysis was performed on Invention Product 1 and Comparison Product 1, which had different results in the sensory evaluation, using the samples preserved at −20° C. Specifically, the concentrations of 2-methyl propanal, 2-methyl butanal, and 3-methyl butanal, which are types of coffee flavor components (volatile components having low boiling points), were measured.

10 mL of the aforementioned samples was put into 20-mL glass containers and sealed with a stopper. The samples were introduced using a headspace sampler (made by Agilent Technologies) and analyzed using a gas chromatograph (made by Agilent Technologies). The operational conditions for the gas chromatography are given below.

Headspace sampler (HP7694, made by Agilent Technologies)

Sample loop: 1 mL

Oven conditions: 60° C. for 15 minutes

Gas chromatograph (HP6890, made by Agilent Technologies)

Column: DB-Wax (60-m length, 0.32-mm inside diameter, 0.25-μm film thickness, made by Agilent)

Injection: 200° C. injection port temperature, 7:1 split ratio

Detector: FID (250° C. detector temperature, 30-mL hydrogen per minute, 400-mL air per minute)

Oven temperature: Held at 40° C. for 5 minutes, increased at 2° C. per minute, held at 230° C. for 20 minutes

The results are shown in Table 2. According to the results in Table 2, the amounts of the various components are greater in Invention Product 1 than in Comparison Product 1. Specifically, it can be seen that, in comparison with normal preservation by freezing, the pH-adjusted sample of Invention Product 1 has greater amounts of the various components than the sample of Comparison Product 1, and that deterioration during long-term preservation by freezing is prevented in Invention Product 1.

TABLE 2

| | | | Peak area (mV · s) | | |
|---|---|---|---|---|---|
| | pH- | Preservation | 2-methyl | 2-methyl | 3-methyl |
| | adjuster | conditions | propanal | butanal | butanal |
| Invention | Sodium | −20° C., 1.5 | 128 | 165 | 107 |
| Product 1 | hy- | months | | | |
| | droxide | | | | |
| Comparison | None | −20° C., 1.5 | 116 | 147 | 95 |
| Product 1 | | months | | | |

(Evaluation 3: Evaluation of Color Tone)

Changes in color during preservation were evaluated.

Changes in external appearance (whether solids were present) and changes in turbidity were evaluated for the samples at the beginning of preservation and after preservation.

External appearance was evaluated by putting 400 mL of the samples into 500-mL beakers and visually verifying the presence or absence of deposits. Changes in turbidity were evaluated using an absorption spectrometer. A Shimadzu Ultraviolet-Visible Light Spectrometer UV-160A made by Shimadzu Corporation was used as the absorption spectrometer, and absorption at 440 nm was measured using glass cells having a cell length of 1 cm. The difference between the value at the beginning of preservation and the value after preservation was calculated to indicate the change in turbidity. The results are shown in Table 3 and Table 4.

TABLE 3
External Appearance

| | Start of | −80° C., 1.5 | −20° C., 1.5 |
|---|---|---|---|
| | preservation | months | months |
| Invention | ∘ | ∘ | ∘ |
| Product 1 | | | |
| Invention | ∘ | ∘ | ∘ |
| Product 2 | | | |
| Comparison | ∘ | ∘ | x |
| Product 1 | | | |

∘: Deposits not present
x: Deposits present

TABLE 4
Results of Color-Change Evaluation

| | Difference in sample | Difference in sample |
|---|---|---|
| | absorption at start of | absorption at start of |
| | preservation and | preservation and |
| | after −80° C. for | after −20° C. for |
| | 1.5 months | 1.5 months |
| Invention | 0.001 | 0.004 |
| Product 1 | | |
| Invention | 0.002 | 0.008 |
| Product 2 | | |
| Comparison | 0.001 | 0.017 |
| Product 1 | | |

According to these results, an effect of improved flavor-component stability due to adjusting pH can be seen for storage at −20° C.

Improvements in stability during preservation by freezing of an aqueous solution containing flavor components are demonstrated by the technique of the present invention as described above.

### Example 2

The effect of adjusting pH on changes in volume during freezing was evaluated.

Invention Product (3): The pH of the aqueous solution containing flavor components obtained in Example 1 was adjusted to 7.2 using sodium hydroxide (made by Kanto Chemical Co., Inc.) as a pH-adjuster, and 72 L of the solution was filled into a sealed 200-L bag-in-box and frozen at −20° C.

Comparison Product (2): 72 L of the aqueous solution containing flavor components obtained in Example 1 was filled directly into a sealed bag-in-box and frozen at −20° C. The volumes of the bags-in-boxes after freezing were measured by inserting the bags-in-boxes into calibrated drums.

The results are shown in Table 5. Adjusting the pH was judged to have minimized volumetric swelling of the bag-in-box, making frozen aqueous solutions containing flavor components exceptionally easy to handle.

TABLE 5

Volume (L)

| | Before freezing | After freezing |
|---|---|---|
| Invention | 72.0 | 102.7 |
| Product 3 | | |
| Comparison | 72.0 | 140.3 |
| Product 2 | | |

### Example 3

The proportion of expansion during freezing of aqueous solutions adjusted to various pH values was measured. Sodium bicarbonate or sodium hydroxide was used as the pH-adjuster. The liquid containing flavor components obtained in Example 1 was prepared to within a range of pH 4.5 to 7.2, and 100 mL of the resulting liquids was put into tubular plastic containers and frozen at −20° C. The volume after freezing was measured using a method in which blocks of ice are placed in a graduated cylinder filled with an appropriate amount of water. The proportion of swelling of the liquids was calculated from the volumes before and after freezing. The results are shown in Table 6.

TABLE 6

Proportion of liquid
swelling during freezing

| pH | NaHCO₃ | NaOH |
|---|---|---|
| 4.5 | 1.33 | 1.33 |
| 6.0 | 1.30 | 1.25 |
| 6.6 | 1.27 | 1.21 |
| 7.0 | 1.24 | 1.13 |
| 7.2 | 1.20 | 1.12 |

The proportion of swelling was high at 1.33 when the pH value was 4.5. The reason is thought to be that the carbon dioxide dissolved during freezing is separated in the gas phase, creating large gaps within the liquid and solidifying. Actual observations of the ice confirmed that a large number of gaps were apparent in the samples having a low pH value.

In comparison with the pH value of 4.5, the proportion of volumetric swelling during freezing was restricted in the range of pH values 6.0 to 7.2. This effect was particularly pronounced in the moderate range (pH 6.6 to 7.2). Particularly when using sodium hydroxide as the pH-adjuster, the proportion of swelling was able to be limited to a range comparable to the proportion of swelling of pure water (approximately 1.1).

It can therefore be understood that adjusting the pH not only has the effect of reducing the generation of carbon dioxide, but also contributes to minimizing volumetric swelling of the liquid during freezing.

### Example 4

The proportion of liquid swelling during freezing was measured for aqueous solutions regulated by different types of pH-adjusters, whereby the effect of reduced volumetric swelling was investigated.

Potassium hydroxide (Nacalai Tesque, Inc.) or trisodium phosphate (Nacalai Tesque, Inc.) was used as the pH-adjuster. The pH value of the liquid containing flavor components obtained in Example 1 was prepared to within a range of 6.5 to 9.8 using the aforementioned pH-adjusters. 80 mL of the resulting solutions was put into 100-mL conical flasks. The conical flasks were then covered with Parafilm and frozen at −20° C. A solution to which a pH-adjuster had not been added was prepared in the same manner to serve as a control.

The volume of the solids after freezing was read from gradations on the conical flask, on which accurate gradations had been inscribed beforehand. The proportion of swelling of the liquid during freezing was calculated from the volumes before and after freezing. The results are shown in Table 7.

TABLE 7

| | | | | | Trisodium | | |
|---|---|---|---|---|---|---|---|
| | Control | Potassium hydroxide | | | phosphate | | |
| pH | 4.5 | 6.5 | 7.2 | 9.8 | 6.5 | 7.1 | 9.4 |
| Swelling | 1.25 | 1.13 | 1.09 | 1.09 | 1.11 | 1.07 | 1.04 |
| proportion | | | | | | | |
| during freezing | | | | | | | |

An effect of a reduced swelling rate in the liquids during freezing is seen because the pH value was adjusted using potassium hydroxide or trisodium phosphate. Considering these results in combination with the results of Example 3 confirms that the technique of the present invention is effective independent of the type of pH-adjuster.

### Example 5

Container-packed coffee beverages were manufactured using Invention Product 3 of Example 2. Invention Product 3 of Example 2 was stored for two months at −10° C. or for six months at −50° C. Upon thawing these samples to room temperature, the volume in each case was reduced to substantially the same level as at the start of preservation. The seals of the bag-in-boxes were opened, and 72 L of aqueous solution containing flavor components was obtained in each case.

Meanwhile, two types of canned coffee beverages were manufactured using standard methods in which the aqueous solutions containing the flavor components were added before heat sterilization, and the cans were sealed after heat sterilization. A taste test performed on the resulting coffee beverages showed that both beverages had an excellent natural coffee-been flavor.

### Example 6

Coffee beverages were prepared using the flavor components of the present invention.

50 kg of roasted coffee beans (a mixture of Brazilian, Colombian, and Guatemalan beans) were mixed with water in a 1:9 ratio and ground to a particle diameter of approximately 1 mm. This liquid was fractionated into volatile components and extract liquid using a Flavourtech SCC (Spinning Cone Column M1,000), which is a type of gas-liquid counter-flow contact extraction apparatus, operating under the conditions below.

Raw-material supply rate: 350 L/hr

Vapor flow volume: 17.5 kg/hr

Amount of vaporization: 17.5 kg/hr

Temperature at bottom of column: 100° C.

Temperature at top of column: 100° C.

Extent of vacuum: Atmospheric pressure

The volatile components were recovered with the water vapor. The resulting volatile components were immediately cooled to 20° C. or less, and 25 liters of an aqueous solution containing flavor components (and having a Brix value 0.2 for the flavor extracts) was obtained. Sodium hydroxide was used as the pH-adjuster, and the pH was adjusted to 6.5. Preservation was at −10° C. in a bag-in-box. The aqueous solution containing flavor components was clear when thawed to room temperature after two months of preservation.

Coffee beverages were prepared using the aqueous solution containing flavor components. A coffee extract (having a Brix value of 3.4) that was obtained separately using an SCC in an operation identical to that described above was processed using a centrifugal separator in order to remove excess solids and then concentrated to a Brix value of 29.9 in a thin-film vacuum concentrator to obtain a concentrated coffee liquid.

The concentrated coffee liquid was supplied to a vibrating cross-flow filtering apparatus (Nihon Pall, Ltd., product name: Pallsep; model: PS-10; film pore diameter: 0.45 μm; film surface area: 0.9 m², filtration flow rate: 13.3 L/m²/hr; filtration temperature: 50° C.), which is a type of cross-flow filter, and a filtered concentrated coffee liquid (highly clarified coffee extract) was obtained. Dilution with water was performed in order to further adjust the concentration, and a highly clarified coffee extract having Brix value of 20 was obtained.

Next, a coffee extract having a normal concentration was obtained separately according to standard methods. Specifically, 410 kg of ground material resulting from the grinding of roasted coffee beans (a mixture of Brazilian, Colombian, and Guatemalan beans) was subjected to extraction in water at 95° C., and approximately 3000 L of coffee extract (coffee extract having a Brix value of 3.5, i.e., a normal concentration) was obtained.

480 kg of the aforedescribed highly clarified coffee extract was admixed with six times that amount of coffee extract (the coffee extract having a normal concentration). Cream, sugar, emulsifiers, and sodium bicarbonate were added in appropriate amounts, and approximately 2.5 wt % of the aforedescribed highly clarified aqueous solution was added. After mixing, the temperature was raised to 70° C., and homogenization was performed at 20 MPa using a homogenizer. The resulting liquid was filled into cans having a capacity of 190 g, sterilization was performed at 125° C. for 20 minutes, and coffee beverages were prepared. When a sensory evaluation was performed on the present coffee beverages, the coffee flavor was satisfactory, being strong, clear, and without any unexpected flavor.

### INDUSTRIAL APPLICABILITY

The present invention can be used as a method for preserving liquids containing natural flavor components derived from food materials.

1. A method for preserving a liquid that contains a flavor component derived from a food material, comprising adding a pH-adjuster to the liquid.

2. The method for preserving a flavor component according to claim 1, comprising preserving without heating the liquid to which the pH-adjuster has been added.

3. The method for preserving a flavor component according to claim 1, wherein the pH of the liquid to which the pH-adjuster is added is 6 to 10.

4. The method for preserving a flavor component according to claim 1, comprising subjecting the liquid to which the pH-adjuster has been added to preservation by freezing.

5. The method for preserving a flavor component according to claim 1, wherein the pH-adjuster is an alkaline substance.

6. The method for preserving a flavor component according to claim 5, wherein the alkaline substance is at least one substance selected from the group consisting of sodium hydroxide, sodium bicarbonate, potassium hydroxide, and trisodium phosphate.

7. The method for preserving a flavor component according to claim 1, wherein the food material is a roasted food material.

8. The method for preserving a flavor component according to claim 7, wherein the roasted food material is selected from the group consisting of coffee beans, tea, oats, barley, brown rice, and sesame seeds.

9. The method for preserving a flavor component according to claim 4, wherein the temperature of the preservation by freezing is −50° C. to −10° C.

10. The method for preserving a flavor component according to claim 1, wherein the liquid to which the pH-adjuster has been added may be added to a container-packed beverage.

11. A method for manufacturing a container-packed beverage, comprising adding a flavor component preserved by the method for preserving a flavor component according to claim 1.

12. A container-packed beverage that is manufactured using the manufacturing method according to claim 11.

13. The container-packed beverage according to claim 12, wherein the container-packed beverage is a coffee beverage.
